(19) United States
(12) Patent Application Publication
(10) Pub. No.: US 2010/0287840 A1
(43) Pub. Date: Nov. 18, 2010

(54) Sectional folding up garage door

(76) Inventor: Vladimir Godovalov, Konotop (UA)

Correspondence Address: Aleksandr Smushkovich, POB 140505, Brooklyn, NY, 11214, US

(21) Appl. No.: 12/658,546

(22) Filed: Feb. 9, 2010

(30) Foreign Application Priority Data
May 15, 2009 (UA) UA200904758

(51) Int. Cl. E05D 15/22

(52) U.S. Cl. 49/226

(57) ABSTRACT

A sectional folding up garage door refers to constructions with moving sectional elements intended for closing apertures in buildings and edifices. The area of invention's application is its use as automatically operated door both for private and commercial use. A sectional folding up garage door provides the sectional panel lifting up in vertical plane, folding such panel in consecutive order by two sections inside a premise as the door is being lifting, and piling compactly inside in the top part of an aperture. The door includes a panel of sections joint one by one like an accordion, a frame and sections power mechanism.

### CROSS-REFERENCE TO RELATED APPLICATION

This U.S. patent application claims priority under 35 U.S.C. 119 (a) through (d) from a Ukrainian patent application UA200904758 filed on 15 May 2009 (now Patent of Ukraine 45043 issued on 26 Oct. 2009), which application is hereby incorporated by reference in its entirety.

### FIELD OF THE INVENTION

The present invention relates to constructions with moving sectional elements intended for closing apertures in buildings and edifices.

### BACKGROUND OF THE INVENTION

Sectional door is known a long time ago and is widely used in all over the world. It comprises several moving sections, the total area of which is equal to the area of the aperture. The panel of a sectional door consists of several rectangular sections joint in consecutive order one by one. Each section can be displaced in one direction only and the displacement maximal angle is no more than 90°. The sections average thickness is 40 mm it is made of light materials—aluminum, plastic etc. The door panel moves on two lateral rails by means of the rollers on the lateral sides of each section. The rails have three sectors—vertical, transition or bending and horizontal sector. In vertical position the sections make a solid panel, closing the garage aperture. While the door is opening the sections move up, pass the bending and then—occupy the top horizontal surface. The door panel in horizontal position is situated in such a way under the ceiling and above the user. The door area remains invariable at that—the sections of such Prior art garage door occupy the same room—both in open and in closed positions.

### SUMMARY OF THE INVENTION

Thus the sections' compact folding property was not implemented in the Prior art garage door, what results in the excessive horizontal area use in the premise in order to place the door panel when the aperture is open. The performance task, being the purpose of this invention hereby, is the considerable reduction of the area occupied with the door panel, when the aperture is open, and keeping their motion in vertical plane, requiring no free space in front of and behind the door at its opening and closing. For the purpose of the task assigned in this invention the panel of sectional construction is implemented, using the property of the joint sections to accordion-fold, in contrary to the section of the Prior art garage door using the section panel flexibility, enabling the panel to move in uneven sectors. The accordion-folding embodiment allows the door panel to be in two static conditions—the completely uncover panel, closing the aperture, and folded panel, where the aperture is open and the panel itself has compact dimensions of one section length and width and a sum of their thickness. Such construction of the panel enables the deviation-free section motion in vertical plane and folding. For implementing the door panel shall be folded consequently by two sections inside the premise, one by one as they are moving upwards. The invention task is hereby—the sectional folding door realization, where the pair-consecutive manner of sections folding is implemented for sectional panels formed from the joint sections having the property of accordion-folding. This idea is implemented in the invention by means of the complex interconnection and interaction of the device construction elements and technical solutions integrity enabling this task.

The invention construction includes three elements—sectional panel, frame and sections power mechanism.

The sectional panel comprises even number of similar width sections, interconnected consequently by bottom and top neighbor wide horizontal sides by means of internal and external hinges placed by turns. For the door panel folding inside the premise the hinges internal line of the panel first section is joined with the frame horizontal sector. The hinges line internal position enables the first section rotate regarding it inside the premise; the next line of hinges, connecting the first section bottom and the second section top, is the external one, and the second section performs rotation outside relative to it etc. Such alternate order of sections joining by means of hinges enables each next section to rotate in the opposite directions regarding the previous section, what results in the sectional panel accordion-folding. The internal and external roller mechanisms are placed on the lateral sides of each section in reverse diagonal order regarding the hinges position. Such displacement is caused by design requirements of the device elements—the sections power mechanism and frame. As the result—on the lateral side of the door panel the roller mechanisms internal and external line is formed. Thus, there is the top external roller mechanism on the first section of the panel, comprising the cable roller, external rail roller and lateral fork hinge placed consequently and coaxially; and the bottom internal roller mechanism, comprising the cable roller and internal rail roller placed coaxially. On the second section of the panel the top internal and the bottom external roller mechanisms are placed, consisting of one cable roller. Such assemblage, besides its asymmetric position provides the roller mechanisms with up to three interconnection elements with other constructive elements. The cable roller, on which the cable of the sections power mechanism is winded, is the first on all roller elements. The second elements, placed on roller mechanisms of the first section only, are internal and external rail rollers, enabling the movement on the frame correspondent rails. The third element, placed on the first section only and behind the external rail roller only, is the lateral fork hinge, with an U-slot on its surface, having such slot an open top edge and a semicircular blind bottom hinge, where the semicircle axis has the same rotation axis with the internal hinge line; and the physical rotation axle for the lateral fork hinge is the axial branch, placed on the frame external rail. The said lateral fork hinge can connect and disconnect to that axial branch, and as a result the section can rotate inside the premise regarding to the axial branch. The above described position of the roller mechanisms is the pair-sectional manner, which is repeated on other pairs of the door panel sections, the length of rollers of the external and internal rails is the only variable characteristic at that. Thus, the external rail roller length of the first pair of sections is the basic length; for each pair of sections following down the external rail roller length increases proportionally. The reverse order is used for the internal rail rollers, where the roller of the given basic length is used for the last pair of sections, having the same proportional increase of length for each pair of sections following up. For the last panel section two supplementary end rollers are used, placed down, off the section width's length, and situated on the same horizontal line—the retaining roller and end roller being longer comparing with the external rail roller maximal length and moving its back plane of this increased sector on the end rail; and between the roller's front side and the external rail there is a minimal clearance, that excludes any blockage of the roller during its movement. The retaining roller's diameter is smaller than the rail rollers' diameter. The retaining roller moves on the internal rail and provides the retaining function, excluding the last section turning inside the premise.

The frame of the invention comprises vertical and horizontal sectors. The vertical sector includes two guides, inside which the sections' rollers move, and comprises the external rail with axial branches and the internal rail with curved sectors. The external rail rollers move on the external rail with axial branches, where the increased length of the rollers increases correspondently the distance of the lateral fork hinge's position on each pair of sections regarding the external rail. The axial branches are placed in the top sector of the external rail. The axial branches are placed vertically, one above another, on the distance of length between the neighbor external rail rollers, when the panel is folded. Those axial branches serve as axles for the lateral fork hinges; they correspond them numerically and have the same proportional continuation regarding the basic length of the bottom axial branch for each axial branch following up. Such property of the distance increasing of the lateral fork hinges placement and of the relevant decreasing of the axial branch length is caused by the task of the consecutive coupling of each pair of sections, having for each section an individual place in the folded position. Thus, the lateral fork hinge of the first pair of sections, when lifting, can couple with the axial branch of the first pair of sections only, where the first pair of sections starts rotating inside and then fold. Then the lateral fork hinge of the second pair of sections passes by all axial branches below and couples with the axial branch of the second pair of sections only etc. As a result all lateral fork hinges shall be coupled with the relevant axial branches in the folded condition of the panel, where in the horizontal position of the section the lateral fork hinge position shall perform the locking function due to the hinge U-slot turning for 90°. The basic length axial branch shall be placed always higher than the vertical segment of the top curved sector, in order to exclude any impediment to the internal roller of the panel first section motion path. This property limits the maximal quantity of the panel sections, where the sum of thickness of all panel sections shall not exceed the section width. The internal rail comprises a straight vertical sector and curved sectors, where their quantity corresponds to the quantity of the internal rail rollers. This curved sector comprises three segments—vertical, reverse concavity or inclination and circular segment, which radius of curvature corresponds to the section width and is equal to the distance from the lateral fork hinge semicircle axis till the rotation axis of this section internal rail roller plus this roller radius. The curved sector on the internal rail is caused by its retaining function, implemented so that the roller, when moving on the curved sector, presses the lateral fork hinge against the axial branch. The curved sectors placement order is individual for each pair of panel sections and depends on the internal rail roller length and height of the axial branch position of this pair of sections. So, the basic length roller of the internal rail is placed on the last pair of sections of the door panel and moves on the internal rail vertical sector up and further—on the basic curved sector being its continuation. The next curved sector's line does not coincide with the internal rail vertical sector; it is displaced from the section lateral side to the length of increasing of the internal rail roller, following up the basic length roller and upwards—to the length of distance between the axial branches, and so on—other curved sectors are placed in a similar way. In order to provide free motion of the internal rail roller during the door closing, the curved sector has in its bottom a reverse concavity segment or inclination sector of the same radius. The length and inclination angle of this segment define the U-slot length and inclination angle of internal edge of the lateral fork hinge slot. To ensure the motion of the end roller of the panel last section there is the end roller rail between the internal and external rails, situated away in the direction opposite to the section lateral side on the distance of equal to this roller length, and having its own length equal to two widths of the section, on the top edge of which there is the end roller, when the door is folded. The frame horizontal sector comprises the rectangular frame, the dimensions of which are equal to the dimension of the section's plane, connected by its front side with the external rail and by its rear side—with the internal rail curved sectors. There is the U-rotary section—rotary frame inside the said frame, having the axial fixation inside the frame horizontal sector through rear ends of the lateral sides, and its front side is connected to the panel top section via the internal line of hinges. The U-rotary section rotates within the horizontal coupling with the frame horizontal sector, where the lateral fork hinge of the first pair of sections is connected with the axial branch of the first couple of sections at the beginning of folding and rotary downwards, until the internal rail roller of the first pair of sections is placed on the vertical segment of the internal rail curved sector. As a result any bending inside by the first pair of sections is excluded, and thus—the door panel is locked. On the frame horizontal sector, above the internal rail rollers, when the door is folded, the traction rollers are placed; and on the lateral sides, above the external rail rollers, in the door closed position—the lifting rollers, which together with the U-rotary section implement the door panel locking mechanism. The winding drum is placed on the frame horizontal sector, behind the traction rollers, but it can also be positioned on their place, executing both their function and the cable winding—simultaneously.

The sections power mechanism includes the elements as follows: cable winding drum, two lifting rollers and two traction rollers, situated on the frame horizontal sector, cable rollers placed on the panel sections and two cables. The manner of cables winding sequence starts from the first pair of sections as follows: winding drum—traction rollers—bottom internal roller of the first section—lifting roller—bottom external roller of the second section—top internal roller of the second section, where cables are fixed if this pair of sections is last or else pulled further on the second pair of sections—bottom internal roller of the first section—top external roller of the first section—bottom external roller of the second section—and are fixed on the top internal roller of the second section if this pair of sections is last; or else from this roller the cables are pulled on the third pair of sections etc. Change in the manner of winding sequence for the first pair of sections through the lifting roller is connected with the purpose of the door locking method implementation. The cable rollers diagonal positioning as a result of their placing coaxially with the rail rollers excludes their touching with the cable passing by. The winding drum rotates in reverse direction, performing the cable winding and unwinding by means of the reduction electric drive.

As a result of solution of the assigned technical task the invention acquires new properties and additional technical result. Among the new positive properties are as follows:
increased hoisting capacity of the device as a result of application of two cables and exclusion of the horizontal sector of the door panel placing; what enables the heavy constructions use for the door panel, broadens the area of the used construction materials application, strengthens the construction reliability and extends the area of the apertures to be closed.
use of force of the door panel weight during the closing—opening process without any additional mechanisms, unlike the Prior art garage door, where spring mechanisms are used for the said purpose, affecting thus reliability and adding certain danger to this item operation.
   Among additional technical results are as follows:
reduction of the time required for opening-closing of the door panel as a result of twice reduction of the guide rail length;
noise reduction during opening-closing of the door panel as a result of absence of the horizontal sector of moving.

### BRIEF DESCRIPTION OF THE DRAWINGS

FIG. 1 is a perspective view of the invention.

FIG. 2 is the manner of cable winding and connection of sections with hinges.

FIG. 3 is a lateral view of the first pair of sections.

FIG. 4 is a view of the external roller mechanism.

FIG. 5 is a view of the internal roller mechanism.

FIG. 6 is a view of the cable roller mechanism.

FIG. 7 illustrates a position of the external roller mechanisms and end roller on the external rail in random order within their operation motion limits.

FIG. 8 illustrates a position of the internal roller mechanisms on the internal rail in random order within their operation motion limits.

FIG. 9 is a lateral view of the door in the closed position.

FIG. 10 is continuation of FIG. 9.

FIG. 11 is a later view of the door in the open position.

FIG. 12 is a top view of the door in the open position.

FIG. 13 is a scaled-up view of the external roller mechanisms of FIG. 12.

FIG. 14 is a scaled-up view of the internal roller mechanisms of FIG. 12.

### DETAILED DESCRIPTION OF THE INVENTION

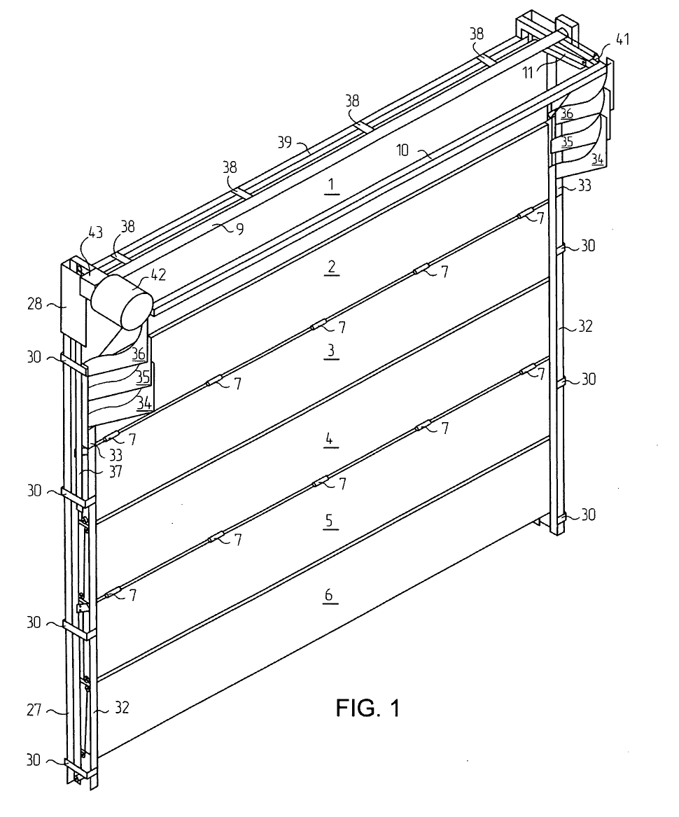

On FIG. 1 the sectional folding up door is represented, including the sectional panel, formed by sections 1, 2, 3, 4, 5, 6, the frame, including vertical part—external rail 27 with axial branches, placed on platform 28, internal rail 32 with curved sectors 34, 35, 36 and end roller rail 37, all rails are interconnected with cramps 30, and horizontal sector 10 having front bar 39 and rotary frame 11. On horizontal sector 10 the elements of the sections power mechanism are placed—winding drum 9, reducer 43, electric motor 42 and cable rollers 12—lifting rollers on lateral sides of horizontal sector 10 and traction rollers on support 41. Dimensions of one section of the invention: length—3000 mm, width—440 mm, thickness—60 mm. Diameters: cable—2 mm, cable rollers and rail rollers—27 mm.

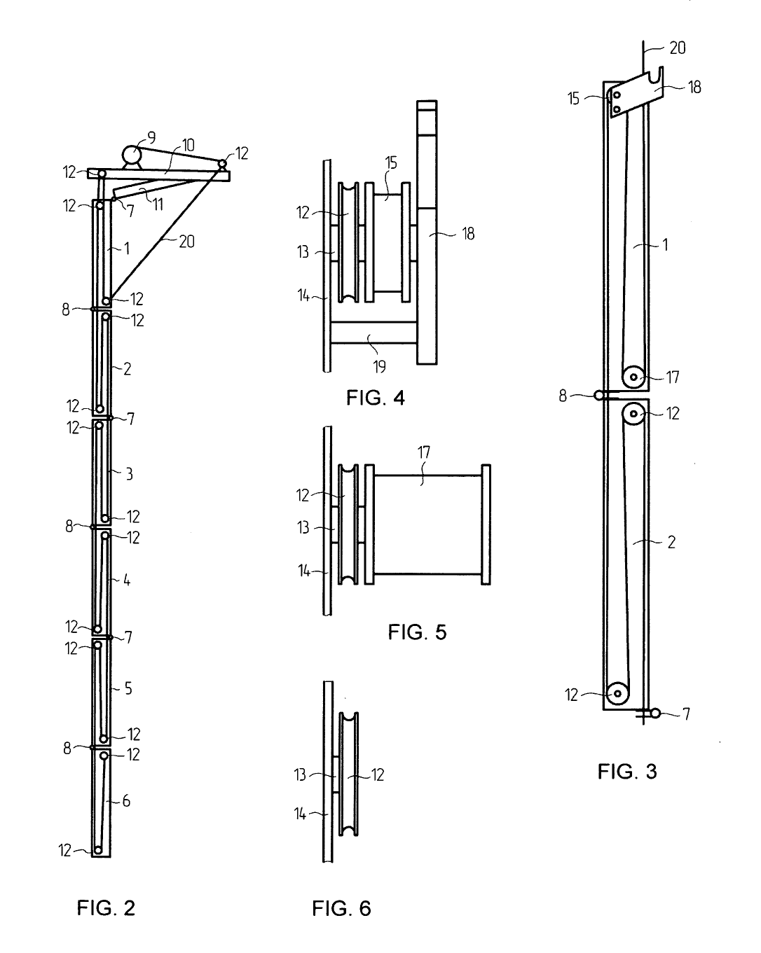

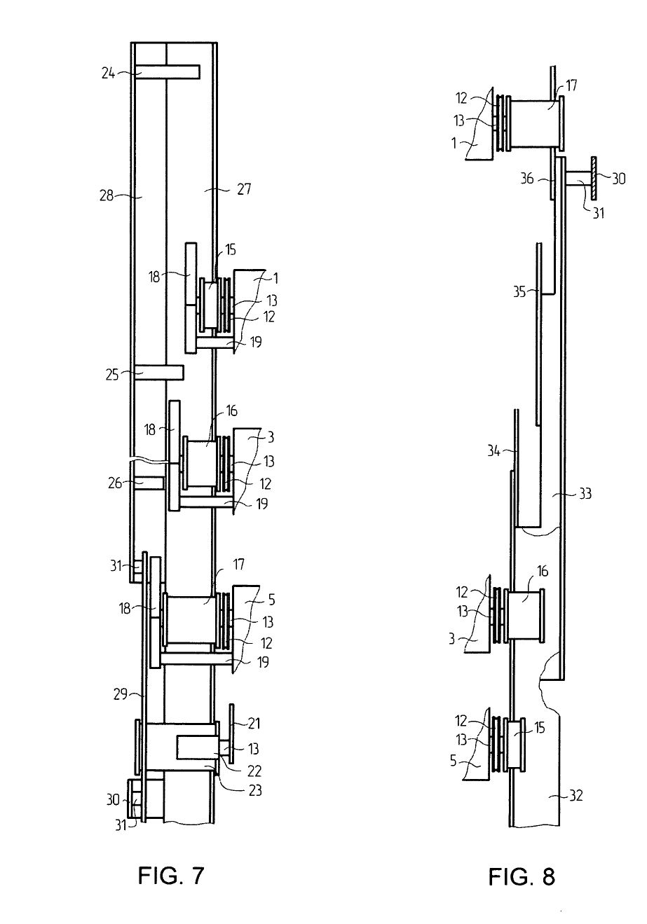

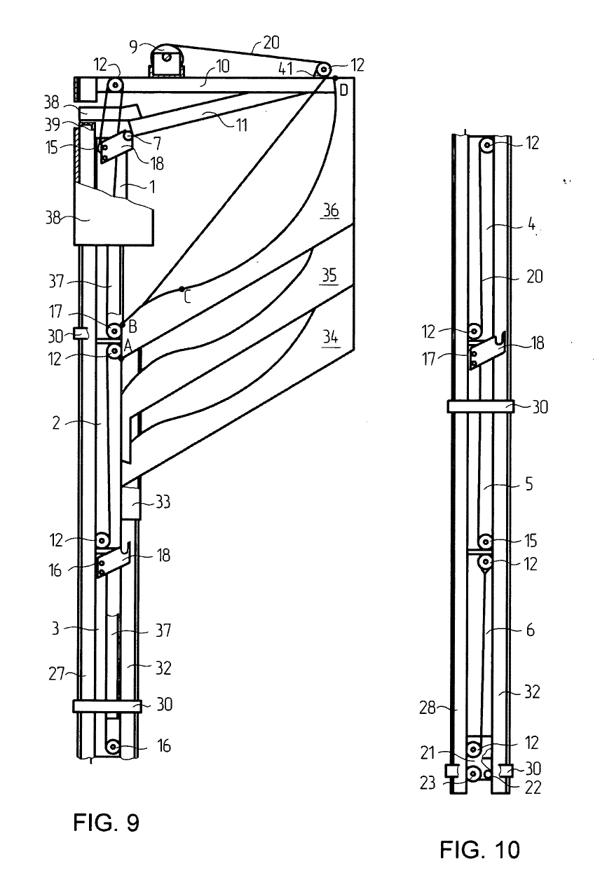

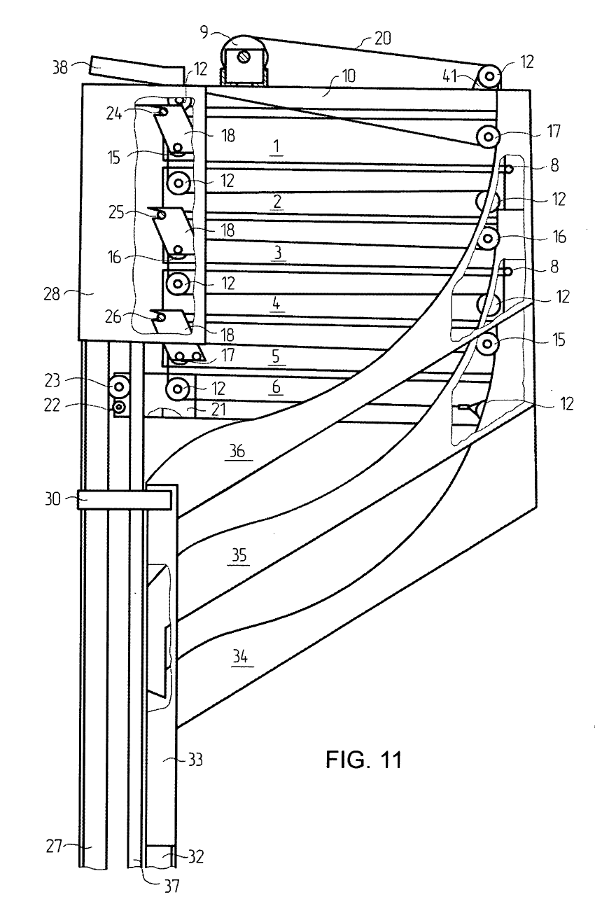

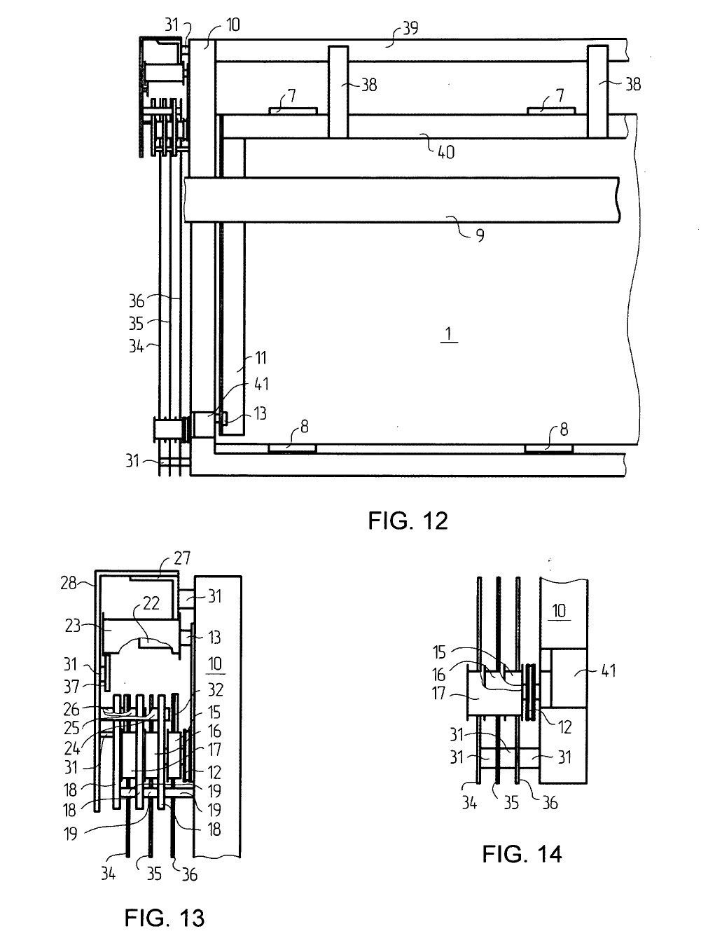

On FIG. 2 the manner of cable winding and connection of sections with internal line hinges 7 and external line hinges 8 are represented. The sectional panel is connected with horizontal sector 10 via rotary frame 11 with internal line hinges 7.
On FIG. 3 the top pair of sections is represented, where the order of roller mechanisms placement is represented, similar to that of other pairs of sections. Thus, in top part of section 1, 3, 5 the external roller mechanism is placed, as shown
on FIG. 4, where to section lateral side's material 14 axle 13 is fixed, on which are in consecutive order are placed as follows: cable roller 12; roller 15—for section 1; roller 16—for section 3 and roller 17—for section 5; lateral fork hinge 18 fixed on axle 13 and on anchor jack 19.
On FIG. 5 the internal roller mechanism is represented, placed in the bottom part of sections 1, 3, 5 and on axle 13 of which are in consecutive order are placed as follows: cable roller 12; roller 17—for section 1, roller 16—for section 3, roller 15—for section 5. On sections 2, 4, 6 the cable roller mechanisms are placed, as shown
on FIG. 6, consisting of one cable roller 12 on axis 13.
On FIG. 7 the vertical correspondence of lateral fork hinges 18 of sections 1, 3, 5 to axial branches 24, 25, 26, fixed on platform 28 is represented; as well as position of end roller 23 and retaining roller 22, placed on plate 21 regarding external rail 27 and end roller rail 29, connected via its joining element 31 with cramp 30. On Figure are shown sections of platform 28, external rail 27, cramp 30, plate 21, sections 1, 3, 5.
FIG. 8 demonstrates relation of rollers 15, 16, 17 lengths with circular sectors 34, 35, 36 positions on step bar 33 regarding internal rail 32. On Figure are shown sections of internal rail 32, step bar 33, cramp 30 and only curved sectors 34, 35, 36. Roller 16 for coupling with its curved sector shall pass the curved sector 34, keeping linear motion, having the curved sector 35 for this purpose an increased vertical segment, as far as it can be seen
on FIG. 9, where the door is closed, and the segments are shown on curved sector 36 as follows: AB—vertical, BC—reverse concavity or inclination, CD—circular segment. In the closed position of the door rotary frame 11 is turned down until limiting elements 38 butt against front bar 39 of horizontal sector 10. At that roller 17 of internal roller mechanism remains on the vertical sector of circular rail 36, and thus any bending inside by the first pair of sections is excluded.
For other pairs of sections this function is performed by lateral fork hinges 18, thrusting against internal rail 32, and for the last section of the sectional panel—end roller 23 and retaining roller 22. Besides as a result of weight force influence on the open door and owing to this method—cable winding and connection of sections with hinges, each rail roller performs a strong pressure against its rail. Rollers edges prevent the door panel lateral displacement. Section 1 is slightly turned inside, but this does not disturb the panel exterior, as over ⅔ of the section remain above the aperture.
FIG. 10 continues FIG. 9. The illustrations represent sections of step bar 33, axial branches platform 28, internal rail 27, end roller rail 37, the first and forth cramp 30 and plate 21.
FIG. 11 represents the door in open condition. There are sections on the platform of axial branches 28, curved sectors 36, 35 and step bar 33. U-slots of lateral fork hinges 18 of sections 1, 3, 5 are connected to axial branches 24, 25, 26, the hinges are turned; as a result the folded sections is hanging on axial branches 24, 25, 26, and cable 20 is holding sections 5 and 6 in horizontal position. Rollers 17, 16, 15 of the internal rail roller mechanisms at that, staying on the curved sectors 36, 35, 34 exclude displacement of the correspondent lateral fork hinge from axial branch.
FIG. 12 represents the sectional view of the left part of the invention with the door folded position, where the rotary frame 11 is shown, the lateral side of which is connected with horizontal sector 10 via axis 13, and front side 40 is connected with section 1 via internal line of hinges 7, and limiting elements 38 are placed on it. On Figure are shown sections of two sides of winding drum 9. Cable 20 is not represented.
FIG. 13 represents positional relationship of lateral fork hinges 18 and curved sectors 34, 35, 36, regarding each other in horizontal plane in the line from the section lateral side, which is necessary to exclude their mutual touching during the external roller mechanisms motion. On Figure are shown sections of axial branches 24, 25, 26 and section of end roller 23. Its position between end rail roller 37 and external rail 27, connected with horizontal sector 10 with joining element 31 is represented.
On FIG. 14 rollers 15, 16, 17 of internal roller mechanisms are represented, where in sections their position on curved rails 34, 35, 36, is shown. These curved rails are interconnected and connected with horizontal sector 10 via joining elements 31. Support 41 of traction function cable roller 12 is fixed on horizontal sector 10.

The further content of this invention can be explained through principal of operation of a sectional folding up garage door.

The process of sectional folding includes the change of the door static position from completely closed, FIG. 9 for completely open, FIG. 11 and inverse.

For the door opening electric motor 42 rotates through reducer 43 winding drum 9 counterclockwise, where cable 20 is winded on winding drum 9. As a result two forces influence on the first pair of sections: lateral, the vector of which coincide with cable 20 and directed from roller 12 of internal roller mechanism of section 1 to traction function cable roller 12; and vertical force, the vector of which coincide with cable 20 and is directed from roller 12 of external roller mechanism of section 2 to lifting function cable roller 12. The total sum of these two forces exceeds the force of weight and as a result the first pair of sections performs lifting and rotating or folding. The process of folding includes three stages. At the first stage the first pair of sections and the whole door starts lifting; at that rotary frame 11 rotates upwards, roller 17 of internal roller mechanism of section 1 moves from vertical segment of curved sector 36 into this sector inclination segment, where the second stage of the process starts. At this stage U-slot of lateral fork hinge 18 of section 1 starts coupling with axial branch 24, and roller 17 moves on the inclination segment of curved sector 36. On the third stage roller 17 of internal roller mechanism of section 1 passes the inclination segment and moves on the circular segment of curved sector 36; U-slot of lateral fork hinge 18 of section 1 coincides completely with axial branch 24 at that; and section 1 rotates regarding this axial branch until the first pair of sections is completely folded. Other pairs of sections lift at that. Folding of the second pair of sections 3 and 4 is similar, the difference is the lateral force vector direction—from roller 12 of internal roller mechanism of section 3 to roller 12 of internal roller mechanism of section 2; and vertical force vector direction is from roller 12 of external roller mechanism of section 4 to roller 12 of external roller mechanism of section 3. The third pair of sections 5 and 6, similar to the second and the first pairs of sections performs movement and folding. Section 6 is the final one and has end roller 23 and retaining roller 22, placed out of the section width size on plate 21, as shown on FIG. 11. The length of end roller rail 37 and its availability is caused by the task of the linear motion of end roller 23 on external roller 27, when sections 5 and 6 are not in the same plane; this task shall be resolved otherwise with retaining roller 22, thrusting against internal rail 32 at the moment of linear positioning of sections 5 and 6.

For the door closing winding drum 9 rotates clockwise, what results in cable 20 supply in reverse direction, i.e. cable unwinding. The main role in this process belongs to the force of weight, the vector of which is directed straight down from roller 12 of external roller mechanism of section 6, FIG. 11. At that the bottom edge of section 6 goes down, end roller 23 moves between external rail 27 and end roller rail 37; roller 15 of internal roller mechanism of section 5 goes down on curved sector 34. Lateral fork hinge 18 of external roller mechanism of section 5 rotates on axial branch 26 as far as this roller passes circular segment of curved sector 34. Then as roller 15 of internal roller mechanism of section 5 moves on inclination segment of curved sector 34 lateral fork hinge 18 of external roller mechanism of section 5 starts to leave axial branch 26; and further, at the process final stage roller 15 of internal roller mechanism of section 5 goes to vertical segment of curved sector 34 and on internal rail 32, and roller 17 of external roller mechanism of section 5 lays on external rail 27; finally sections 6 and 5 are completely open and go downwards. The process of closing of sections 4 and 3 and then sections 2 and 1 is similar. At the end of the process rotary frame 11 is turned down until limiting elements 38 butt against front bar 39. Thus the door closing is finished.

1. A sectional folding up garage door comprising:
a sectional panel formed by an even quantity of sections of the same width interconnected consequently by bottom and top neighbor horizontal sides by means of internal and external hinges placed by turns, and having on lateral sides of each section internal and external roller mechanisms which are placed in reverse diagonal order regarding said hinges position, wherein said roller mechanisms include one or two rollers, or two rollers along with a lateral fork hinge and two supplementary end rollers placed on the last section;
a frame including two vertical guides, inside which rollers of said roller mechanisms move, wherein said guide comprises an external rail with axial branches, an internal rail with curved sectors having circular segments of the radius of the section width and end roller rail, and wherein said frame has a horizontal sector equal to the section's plane, including inside a rotary frame;
a sections power mechanism including a cable winding drum, two lifting rollers and two traction rollers both situated on the rear and front side of said horizontal sector correspondently, cable rollers of sections and two cables, and whereon the manner of cables winding for the top pair of sections is as follows: winding drum—traction rollers—bottom internal rollers of first section—lifting rollers—bottom external rollers of second section—top internal rollers of second section—the next pair of sections if available or else said cables are fixed on these last rollers.

2. A sectional folding up garage door according to claim 1, wherein said sectional panel has a pair-sectional manner of panel forming, a quantity of section which, is from one pair and up to any even quantity with the maximal sum of their thickness not exceeding the section width.

3. A sectional folding up garage door according to claim 2, wherein each pair of sections the top section has bottom internal position of a cable roller and internal rail roller and top external position of a cable roller, an external rail roller and lateral fork hinge, and the bottom section of said pair has top internal position and bottom external position of cable rollers, and wherein such order of their placement on axles exists in the direction from lateral sides of sections.

4. A sectional folding up garage door according to claim 3, wherein external rail rollers have a proportional increasing of length regarding a basic length of the external rail roller placed on the top pair of sections for each following down pair of sections, and wherein similar increasing in reverse direction for internal rail rollers having the given basic length for the last pair of sections exists.

5. A sectional folding up garage door according to claim 1, wherein said curved sectors have numerical and mutual correspondence to internal rail rollers, and their position, when sectional panel is folded and regarding the basic curved sector which is continuation of an internal rail on which the internal rail roller of basic length moves, changes vertically upwards for each next curved sector on the length of distance between internal rail neighbor rollers and horizontally from the panel lateral side on the length of increasing of the correspondent internal rail roller.

6. A sectional folding up garage door according to claim 1, wherein said axial branches have numerical and mutual correspondence to lateral fork hinges and during the sectional panel folding they serve as physical rotation axles for lateral fork hinges having a common axle of their U-slot semicircles with internal hinges line, and wherein said axial branches have regarding their lower basic length the length increasing for each axial branch following up on the index of decreasing of the correspondent external roller length, and are mutually placed vertically on the distance equal the length between external rail neighbor rollers when sectional panel is folded.

7. A sectional folding up garage door according to claim 1, wherein said curved sectors include segments as follows: vertical, reverse concavity or inclination and circular segment.

8. A sectional folding up garage door according to claim 1, wherein said manner of cables winding has continuation on said next pair of sections as follows:—bottom internal rollers of first section—top external rollers of first section—bottom external rollers of second section—top internal rollers of second section—and further this sequence is repeated on the next pair of sections if available or else said cables are fixed on these last rollers.

9. A sectional folding up garage door according to claim 1, wherein said rotary frame, a U-shaped rotary section has axial fixation inside of said horizontal sector of said frame through rear ends of lateral sides, and its front side is connected to the panel top section via internal hinges, and wherein said rotary frame rotates within the limits of horizontal coupling with said frame and turning down till internal rail rollers of the top section dispose on vertical segments of correspondent curved sectors.

10. A sectional folding up garage door according to claim 1, wherein said two supplementary end rollers are a retaining roller and end roller both placed downwards out of the last section width size, remaining in the same horizontal line, wherein said end roller is longer regarding the external rail roller maximal length and moves by the rear surface of the enlarged sector on an end roller rail placed between an internal and external rail and the end roller front side is on a minimal distance to an external rail excluding thus this roller locking.
